(19) United States
(12) Patent Application Publication
(10) Pub. No.: US 2006/0168000 A1
(43) Pub. Date: Jul. 27, 2006

(54) Method of sharing files between user stations in a network

(76) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/546,312

(22) PCT Filed: Feb. 18, 2004
(86) PCT No.: PCT/IB04/50126

§ 371 Date: Aug. 19, 2005

(30) Foreign Application Priority Data
Feb. 28, 2003 (EP) 03100494.8

(51) Int. Cl. G06F 15/16

(52) U.S. Cl. 709/205

(57) ABSTRACT

A method of sharing files between user devices connected to a common network, e.g. in accordance with IEEE 802.11b, where each user device can detect and use services of the other user devices. According to the invention the method comprises the steps of creating a shared folder in each user device and attributing a common identity to the shared folders. A file to be shared with the other user devices is placed in the shared folder of the first user device, and thereby made available as a service to the other user devices. In each of the other user devices, the shared folders of the other user devices are monitored, and when a file to be shared has been placed in a shared folder of one of the other user devices, the file is downloaded.

Wireless local networks such as IEEE 802.11b networks are becoming more and more widespread in office and other professional environments, and are being introduced in private homes, too. Such local networks enable user devices, and in particular portable user devices such as laptop computers, personal digital assistants (PDA's) etc. to connect to an office infrastructure and to each other.

With today's technology there is a problem when users that are connected to an ad hoc network want to share a file such as a document with other uses of the network. An example scenario is a meeting room, where each participant has his own laptop computer or other user device, and some or all of the participants each has one or more files to be shared with the other participants. This involves the following active steps to be performed:

A folder must be set up, which has shared read/write permissions,

each participant places his data to be shared in a shared folder, and

each participant retrieves all data from the shared folder.

This is inconvenient, since all parties must manually synchronize their steps of placing their data in the shared folder and of retrieving new data and updates from the shared folder.

According to the invention, a structure is defined that goes beyond the basic service framework and its service. Specifically, we define a fixed folder, with an identity defined by the user. The essential element here is that users on different devices agree on the same identity and thus agree on participating in the same shared folder. Here, a “folder” corresponds to a “container” as used in the UPnP AV Architecture discussed below. Accidental confusion with existing folders (containers) can easily be avoided by adding a shared-folder specific part to the identity. For example: users select folder identity “meeting1”. In a Bluetooth ftp profile this would be translated to “/sharedfolders/meeting1”, where “/sharedfolders/” is the shared-folder specific part.

A use model is defined that goes beyond the basic use model of the service framework and its service. Specifically, the use model of the invention comprises the following characteristic features:

1) Whenever a user chooses to share content such as a file, the file is added to the “content” service of the device of the user.

2) Each user device monitors the “content” services of other user devices connected to the network with the purpose of detecting possible new content and automatically downloads thus discovered content.

The invention preferably uses the Universal Plug and Play (UPnP) ContentDirectory Service (CDS) and Control Points on each user device. The current version is the UPnP AV Architecture:0.83 for Universal Plug and Play Version 1.0. Status: Preliminary Design (TPD), date: Jun. 12, 2002, not yet finished. Other documents, specifically the ContentDirectory:1 specification, have been standardized.

The AV (audio-visual) Architecture defines the general interaction between UPnP Control Points and UPnP AV devices. It is independent of any particular device type, content format, and transfer protocol. It supports a variety of AV devices such as TVs, VCRs, CD/DVD players/jukeboxes, settop boxes, stereo systems, MP3 players, still-image cameras, camcorders, electronic picture frames (EPFs), and the PC. The AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET, RTP, HTTP PUT/POST, TCP/IP, etc.). The document describes the AV Architecture and how the various UPnP AV devices and services work together to enable various end-user scenarios.

The UPnP AV Architecture was explicitly defined to meet the following goals:

To support arbitrary transfer protocols and content formats.

To enable the AV content to flow directly between devices without any intervention from the Control Point.

To enable Control Points to remain independent of any particular transfer protocol and content format. This allows Control Points to transparently support new protocols and formats.

Scalability, i.e. support of devices with very low resources, especially memory and processing power as well as full-featured devices.

In most (non-AV) UPnP scenarios, a Control Point controls the operation of one or more UPnP devices in order to accomplish the desired behavior. Although the Control Point is managing multiple devices, all interactions occur in isolation between the Control Point and each device. The Control Point coordinates the operation of each device to achieve an overall, synchronized, end-user effect. The individual devices do not interact directly with each another. All of the coordination between the devices is performed by the Control Point and not the devices themselves.

Most AV scenarios involve the flow of (entertainment) content (i.e. a movie, song, picture, etc.) from one device to another. An AV Control Point interacts with two or more UPnP devices acting as source and sink, respectively. Although the Control Point coordinates and synchronizes the behavior of both devices, the devices themselves interact with each other using a non-UPnP (“out-of-band”) communication protocol. The Control Point uses UPnP to initialize and configure both devices so that the desired content is transferred from one device to the other. However, since the content is transferred using an “out-of-band” transfer protocol, the Control Point is not directly involved in the actual transfer of the content. The Control Point configures the devices as needed, triggers the flow of content, then gets out of the way. Thus, after the transfer has begun, the Control Point can be disconnected without disrupting the flow of content. In other words, the core task (i.e. transferring the content) continues to function even without the Control Point present.

As described in the above scenario, three distinct entities are involved:

the Control Point,

the source of the media content (called the “MediaServer”), and

the sink for the content (called the “MediaRenderer”).

Today the most common task that end-users want to perform is to render (i.e. play) individual items of content on a specific rendering device. A content playback scenario involves three distinct UPnP components: a MediaServer, a MediaRenderer, and a UPnP Control Point. These three components (each with a well-defined role) work together to accomplish the task. In this scenario, the MediaServer contains (entertainment) content that the user wants to render (e.g. display or listen to) on the MediaRenderer. The user interacts with the user interface (UI) of the Control Point to locate and select the desired content on the MediaServer.

The MediaServer contains or has access to a variety of entertainment content, either stored locally or stored on an external device that is accessible via the MediaServer. The MediaServer is able to access its content and transmit it to another device via the network using some type of transfer protocol. The content exposed by the MediaServer may include arbitrary types of content including video, audio, and/or still images. The content is transmitted over the network using a transfer protocol and data format that is understood by the MediaServer and MediaRenderer. MediaServers may support one or multiple transfer protocols and data formats for each content item or may be able to convert the format of a given content item into other formats on the fly. Examples of a MediaServer include a VCR, CD/DVD player/jukebox, camera, camcorder, PC, set-top box, satellite receiver, audio tape player, etc.

The ContentDirectory Service, CDS, provides a set of actions that allow the Control Point to enumerate the content that the MediaServer can provide to the home network. The primary action of this service is Browse( ). This action allows Control Points to obtain detailed information about each Content Item that the MediaServer can provide. This information (i.e. meta-data) includes properties such as its name, artist, date created, size, etc. Additionally, the returned meta-data identifies the transfer protocols and data formats that are supported by the MediaServer for that particular Content Item. The CDS preferably supports HTTP-GET of arbitrary files.

For maximum convenience, it is highly desirable to allow the user to initiate these operations from a variety of user interface (UI) devices. In most cases, these UI devices will either be a UI built into the rendering device, or it will be a stand-alone UI device such as a wireless PDA or tablet PC. In any case, it is unlikely that the user will interact directly with the device containing the content (i.e. the user won't have to walk over to the server device). In order to enable this capability, the service device needs to provide a uniform mechanism for UI devices to browse the content on the server and to obtain detailed information about individual content objects. This is the purpose of the ContentDirectory Service, CDS.

The UPnP AV Architecture defines a Container, which is a first-level class derived directly from a root-level object class. A container represents a collection of objects. Containers can represent the physical organization of objects (storage containers) or logical collections also known as folders. Logical collections can have formal definitions of their contents or they can be arbitrary collections. Containers can be either homogeneous, containing objects that are all of the same class, or heterogeneous, containing objects of mixed class. Containers can contain other containers. Any object derived from the container class is expressed via the DIDLLite container structure. A CDS (ContentDirectory Service) is required to maintain a ContainerUpdateID for each of its containers. This value is maintained internally, does not appear in any XML expression of the container, and cannot be used in a search or sort criterion.

A container is considered modified when any of the following occurs:

A property of the container is added, removed or changed in value,

A direct child element, whether object-derived or ordinary element, is added to or removed from the container,

A direct, non-container-derived, child object has one of its properties or child elements added, removed or changed, or

A direct container-derived child element has one of its properties or non-object-derived child elements added, removed or changed.

Unlike most other service templates, the ContentDirectory Service, CDS, is primarily ‘action’ based. The service's state variables exist primarily to support argument passing of the service's actions. Information is not exposed directly through explicit state variables. Rather, a client retrieves ContentDirectory Service information via the return parameters of the actions defined below. The majority of state variables defined below exist simply to enable the various actions of this service.

A CreateObject action creates a new object in the container identified by ContainerID. The new object is created with the required id attribute set to “ ” and the required restricted attribute set to false. The actual value of the id attribute is supplied by the ContentDirectory Service.

A DestroyObject action destroys the specified object when permitted. If the object is a container, all of its child objects are also deleted, recursively. Each deleted object becomes invalid and all references to it are also deleted. The ContentDirectory Service is allowed (but not required) to delete a resource when it detects, with absolute certainty, that there are no references to it left anywhere in the ContentDirectory Service after the DestroyObject( ) action.

An UpdateObject action modifies, deletes or inserts object metadata. The object to be updated is specified by ObjectID. CurrentTagValue is a CSV list of XML fragments. Each fragment is either the complete, exact, current text of an existing metadata element of the object or an empty placeholder. NewTagValue is also a CSV list of XML fragments, each of which is the complete new text of a metadata element for the object or an empty placeholder. The two tag/value lists must have the same number of entries. Each entry in CurrentTagValue represents metadata to be modified. The corresponding entry in NewTagValue represents the new, replacement metadata for the element identified by CurrentTagValue.

All participants should have a device that has the following characteristics:

it should be able to communicate with all other participants, preferably through a network,

it should run the same service framework. A service framework should allow detection of other devices and their services, and allow use of these services. Examples of service frameworks are UPnP, HAVi and Bluetooth,

it should run a “content” service that allows discovery and downloading of content by other devices, and allows named sets of contents to be represented (e.g. as directories, folders, containers). An example of such a service is the UPnP Content Directory Service, or the Bluetooth ftp profile.

it should be able to use this service on other devices. For example, it should be a UPnP control point, capable of accessing ContentDirectory Service, or it should be able to access an ftp profile over Bluetooth.

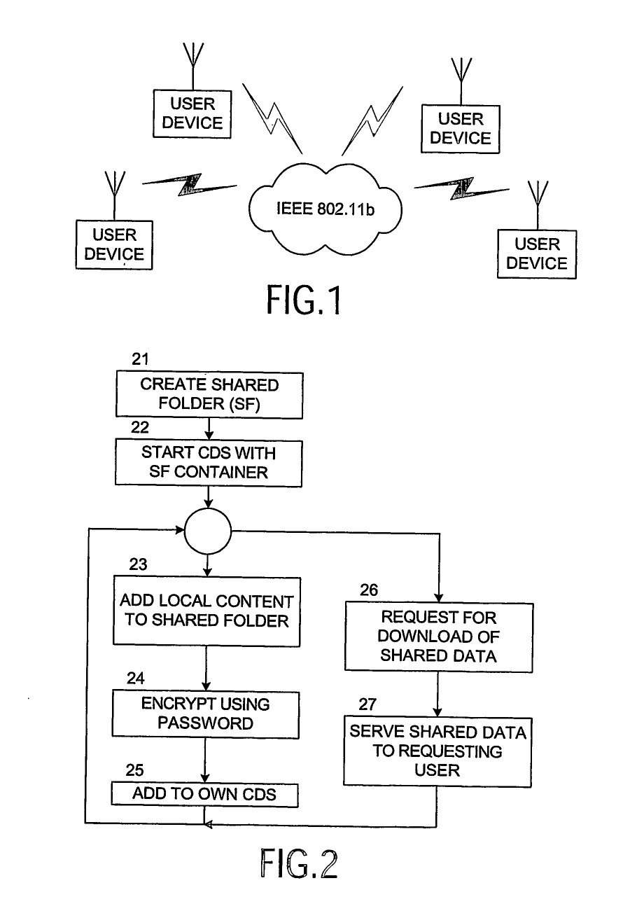

FIG. 1 shows schematically a preferred network with several user devices operating in accordance with the invention,

FIG. 2 shows the main steps performed by a user device when sharing a file with other user devices of the network,

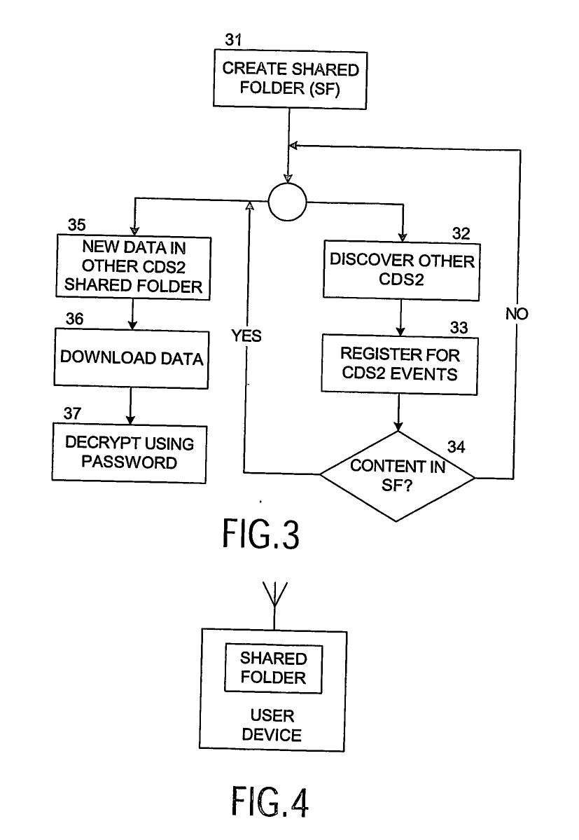

FIG. 3 shows the main steps performed by a user device when downloading a shared file from another user device, and

FIG. 4 shows schematically a user device in accordance with the invention.

In the following a preferred embodiment of the invention will be described.

FIG. 1 illustrates a scenario in a meeting room, where several users (not shown) each have a user device. The user devices are personal devices that are capable of communicating with other devices through a network such as a network operating in accordance with the IEEE 802.11b as shown. The skilled person will understand that the chosen standard IEEE 802.11b is just an example, and that networks operating in accordance with other standards can be used. Examples of user devices are a laptop computer, a personal digital assistant (PDA), a digital camera, a mobile phone. A plurality of such user devices is connected to the network.

A user device for use in the system according to the invention has the following characteristics:

it is capable of connecting to a network,

it is capable of detecting at least one other user device and of communicating, using the network, with the at least one other user device,

it is capable, using the network, of detecting and of using services of the at least one other user device,

it has means for creating a folder and for attributing a predetermined identity to the folder,

it is capable of placing, in the folder, a file to be shared with the at least one other user device, and thereby making the file to be shared available as a service to the at least one other user device, and

it is capable of monitoring, on the at least one other user device, a folder having the same predetermined identity attributed thereto, and when a file to be shared has been placed in a folder with the predetermined identity of the at least one other user device, downloading the file to be shared.

The network and the user devices preferably use the above-mentioned Universal Plug and Play ContentDirectory Service and Control Points. Each user device runs the same service framework that allows detection of other user devices and their services, and allows use of these services. Examples of service frameworks are UPnP, HAVi, and Bluetooth. Further, each user device runs a “content” service that allows detecting and downloading of content from other user devices, and allows named sets of contents to be represented (e.g. as directories, folders, containers). The preferred embodiment of the invention uses the UPnP ContentDirectory Service. Finally, each user device is able to use the services on other user devices. There is thus a UPnP control point, capable of accessing a ContentDirectory Service, or it should be able to access an ftp profile over a Bluetooth connection. The client is thereby enabled to control a “content” service.

FIG. 2 illustrates the significant steps performed by a user device when sharing a file in the user device with other user devices of the network.

Initially, when each user device connects to the network, a local folder or container is created in the user device connected to the network, in step 21, and all thus created folders are given a common identity. The common identity ensures that folders with the common identity on different user devices are treated by the system as a single logical folder, and files will thereby be automatically replicated from one user device to each of the other user devices. In the following the thus created folders with a common identity are referred to as “shared folders”. When the shared folders have been created, the ContentDirectory Service is started, in each user device, with the shared folder, in step 22.

At any time during the meeting (or other session) participating users can place one or more files to be shared into their respective shared folder, whereby these folders will automatically be transferred to all other user devices with a shared folder. This is indicated in step 23. The users can place their files to be shared in their shared folder e.g. by the well-known drag-and-drop method.

In step 24, the user can choose to encrypt the file or files that he has placed in his shared folder and protect the contents with a password, whereby the contents will only be shared with other users, who have the password. This step is optional. Typically, this is configured once for a specific shared folder and applies to all files in the shared folder.

In a user device there can be multiple shared folders with different identities and different passwords. This allows the user to share data with different groups of people at the same time.

After having added his local content to be shared to the shared folder and possibly also having encrypted the content, the content is added to the user's own ContentDirectory Service in step 25. This step comprises:

creating a new UPnP object in the shared folder container,

adding the right meta-data to the object such as its title and a URL from which it can be obtained,

updating all affected change-numbers in the CDS, and

notification of all subscribing control points of the change.

In step 26, the user device receives, from another user device, a request for download of the shared file or other data, and in step 27 the requested data is served to the requesting user device.

Preferably, the method of the invention uses the Universal Plug and Play ContentDirectory Service and Control Points on each user device. The shared folder is implemented by a container with a specific name and can be browsed on the ContentDirectory Service of each user device.

FIG. 3 illustrates the significant steps performed by a user device when obtaining a shared file from another user device of the network. Like in FIG. 2 the method requires a shared folder to be created as an initial step 31 when connecting to the network.

In step 32 the user device discovers or detects the CDS (CDS2) of another user device. This requires either that the other user device has announced itself to the control points, or that the control points can send “M-SEARCH” messages, to which the CDS2 can respond. The control point implementation can use a mix of these to optimize results.

In step 33 the requesting user device establishes a “subscription” to the CDS service, which means that the requesting user device becomes registered with the other user device to be alerted of CDS events on the other user device.

In step 34 the control point will examine the CDS2 using e.g. standard browse/search commands. For example, a search for a folder named “SharedFolder_xxx”, where xxx is a name chosen by the users, would return its ID. A subsequent “browse” command with the ID as a parameter will return a list of contents in this folder. Depending on whether or not there is content in the shared folder, the process will either proceed to step 35 or to the start.

In step 35 it has been established that there is content in the shared folder. The control points can then discover that there is new data in the shared folder of another CDS (CDS2) either by searching/browsing the CDS2, possibly periodically, or by receiving an event form the CDS2. A mix of these two methods can be used for obtaining best results, e.g. reliability. Each container is attributed a ContainerUpdateId, which is a number that changes whenever the content of the container changes. This enables fast localization of updates in a content directory.

In step 36 the identified data is downloaded from the CDS2 after having browsed the CDS2 to discover new content items in step 35, and having retrieved meta-data of the new content items that include a URL, and finally downloading this data by using HTTP-GET.

In step 37 encrypted data is decrypted using the agreed password. If data is not encrypted, decryption is not performed.

FIG. 4 shows schematically a user device comprising a shared folder in accordance with the invention.

Users may choose not to download all data offered from other user devices, and each user can thus have his own user policy of downloading data offered for sharing by other user devices, whereby only data fulfilling certain criteria are downloaded. Such “filtering” of the offered data can include download only upon user acceptance, or automatic acceptance or exclusion depending on type or size of file, whether a file is a new file or an amendment to an earlier file, or which actions that have previously been taken on the file or an earlier version thereof, etc.

In the user-interface, the local administration can be visualized, typically merging own shared content with downloaded content.

When a user device puts a new file into its shared folder, the user device actively announces this on the network using the UPNP subscription mechanism, and all user devices subscribe or “listen” to such announcements. When a new file is announced on the network, each user device downloads the new file to its shared folder, or can choose to do so. If a user deletes a shared file in his shared folder, this will result in that the shared file is no longer available over the network, but the shared file will not be automatically deleted in the other user devices.

When the user device is e.g. a laptop computer running Microsoft Windows operating system a possible user interface is the following. When right-clicking on the desktop, select “new”. Just under “new folder” a tab “new SHARED folder” is added. When selected, a new shared folder is created, and the user can set its name and (optionally) password, and (optionally) a time-out after which the folder automatically reverts to a normal folder. The user can now drag files/directories (with files/directories) into this folder, just as any normal folder. This will cause these to be shared over the network. Typically, at the end of a meeting there is no longer a need for sharing a folder. A shared directory can thus be automatically unshared after a predetermined period of time. Automatically reverting to a normal folder is an advantage, since a user will not unintentionally keep sharing a directory forever.

Whenever any other device shares a file/directory, this automatically appears in the shared folder, e.g. in a directory “DEVICE_xxx”, where xxx is the name that identifies the device (this would be the UPnP friendly name, or UPnP device ID). Furthermore, there is an extra column “download status” that can hold “downloading”, “local copy”, “rejected/deleted”, “original removed”. A UI option is to hide downloading and/or rejected/deleted items, since their contents are not actually present. A user can download a deleted content again by right clicking a “rejected/deleted” item and select “force download”.

1. A method of sharing a file in a first user device with at least one other user device, the first and the at least one other user devices being connected to a common network, each user device being able to detect other user devices connected to the network and to communicate with the other user devices, and each user device being able to detect and to use services of the other user devices connected to the network, the method comprising the following steps:
creating, in each user device, a shared folder,
attributing a common identity to the shared folders,
placing, in the shared folder of the first user device, a file to be shared with the at least one other user device, and thereby making the file to be shared available as a service to the at least one other user device,
in each of the at least one other user device, monitoring the shared folders of the other user devices connected to the network, and when a file to be shared has been placed in a shared folder of one of the other user devices, downloading the file to be shared.

2. A method according to claim 1 characterized in that each shared folder is attributed a further identity that is unique to the related user device, and that files from the first user device are placed in the shared folder with the further identity that is unique to the first user device.

3. A method according to claim 1 characterized by the following further step:
deciding, depending on properties of the file to be shared, on whether or not to download the file to be shared to the at least one other user device.

4. A method according to claim 1, characterized by the following further steps:
prior to being placed in the shared folder of the first user device, encrypting the file to be shared, and
decrypting, in the at least one other user device, the encrypted file to be shared.

5. A method according to claim 1, characterized in that the network is in accordance with the IEEE 802.11 standard.

6. A method according to claim 1, characterized by the use of Universal Plug and Play ContentDirectory Service and Control Points.

7. A method according to claim 1, characterized in that a shared directory is automatically being unshared after a predetermined period of time.

8. A user device for use with a method according to claim 1, characterized in that the user device:
is capable of connecting to a network with at least one other user device connected to the network,
is capable of detecting the at least one other user device and of communicating, using the network, with the at least one other user device,
is capable, using the network, of detecting and of using services of the at least one other user device,
has means for creating a folder and for attributing a predetermined identity to the folder,
is capable of placing, in the folder, a file to be shared with the at least one other user device, and thereby making the file to be shared available as a service to the at least one other user device,
is capable of monitoring, on the at least one other user device, a folder having the same predetermined identity attributed thereto, and when a file to be shared has been placed in a folder with the predetermined identity of the at least one other user device, downloading the file to be shared.

9. A user device according to claim 8, characterized in that it is capable of encrypting and of decrypting files to be shared.

10. A user device according to claim 8, characterized in that it is capable of operating in a network in accordance with the IEEE 802.11 standard.

11. A user device according to claim 8, characterized in that it is capable of using Universal Plug and Play ContentDirectory Service and Control Points.
